(19) United States
(12) Patent Application Publication
(10) Pub. No.: US 2009/0142169 A1
(43) Pub. Date: Jun. 4, 2009

(54) Vacuum Assisted Manipulation of Objects

(75) Inventors: Edward Garcia, Holbrook, MA (US); Richard W. Slocum, III, Amherst, NH (US)

Correspondence Address: FISH & RICHARDSON P.C., P.O. BOX 1022, MINNEAPOLIS, MN, 55440-1022, US

(73) Assignee: Teradyne, Inc.

(21) Appl. No.: 12/323,722

(22) Filed: Nov. 26, 2008

Related U.S. Application Data
(60) Provisional application No. 60/991,523, filed on Nov. 30, 2007.

(51) Int. Cl. B65H 1/28; B66F 9/18; B65G 53/34

(52) U.S. Cl. 414/222.02; 414/225.01; 414/226.04; 414/814; 406/117

(57) ABSTRACT

A disk drive handling apparatus includes a manifold, one or more vacuum suction elements in fluid communication with the manifold, and one or more tips. Each tip is coupled to an end of a corresponding one of the vacuum suction elements. Each tip is compliant in one or more axes of motion.

This application claims benefit from U.S. Provisional Patent Application No. 60/991,523, filed November 30, 2007, the entire contents of which are incorporated herein by reference.

### TECHNICAL FIELD

This disclosure relates to vacuum assisted manipulation of objects, and more particularly to vacuum assisted extraction and replacement of disk drives retained in cavities (e.g., slots and/or receptacles).

### BACKGROUND

Hard disk drives (HDDs) are typically manufactured in mass volume. Final assembly of the internal components into a case, as typically seen by a consumer, is performed in a cleanroom, with associated circuit board(s) added as a final physical assembly step except, perhaps, for the addition of a label.

After the final assembly, HDDs are typically individually placed into slots of a carrier known as a tote. Totes are generally of a size that can be carried for short distances by an individual and contain a multitude of slots, each retaining a single HDD. As the tote is moved about the HDD factory to various post-assembly manufacturing processes, the HDD is removed, processed for another step (e.g., final test, labeling, packing), and re-inserted into the tote slot for transport to the next manufacturing process step.

Reduction of cost is an important element of electronics manufacture, and results in totes being equipped with the largest number of individual HDD-retaining cavities (“slots” or “receptacles”) as possible within the exterior-wall limits of the tote structure. As a result, the HDDs are closely spaced within a tote and present limited surface area for engagement by a mechanism to grip the HDD during extraction from and reinsertion into a slot.

Because the delicate nature of HDDs restricts the force which may be applied to the various HDD surfaces and because of the aforementioned close-spacing of HDDs within the totes, extraction and re-insertion are generally performed by a human, gripping the small area of the HDD which presents itself beyond the front edge of the tote. In general, robotic gripping of the HDD unit, especially areas of the HDD which present themselves beyond the front of the slot, is discouraged because of the risk of damage if excessive force is applied.

### SUMMARY

In one aspect, a disk drive handling apparatus includes a manifold, one or more vacuum suction elements in fluid communication with the manifold, and one or more tips. Each tip is coupled to an end of a corresponding one of the vacuum suction elements. Each tip is compliant in one or more axes of motion.

In another aspect, a disk drive handling apparatus includes a manifold, one or more vacuum suction elements in fluid communication with the manifold, and a compliant pad. The compliant pad includes a plurality of passages that are in fluid communication with the one or more vacuum suction elements.

In a further aspect, a disk drive handling system includes a vacuum source, a manifold in fluid communication with the vacuum source, one or more vacuum suction elements in fluid communication with the manifold, and one or more tips. Each tip is coupled to an end of a corresponding one of the vacuum suction elements. Each tip is compliant in one or more axes of motion.

In yet another aspect, a disk drive handling system includes a vacuum source, a manifold in fluid communication with the vacuum source, one or more vacuum suction elements in fluid communication with the manifold, and one or more compliant pads. The one or more compliant pads include a plurality of passages in fluid communication with the one or more vacuum suction elements.

In another aspect, a method of handling a disk drive includes engaging one or more surfaces of a disk drive with an end effector. The end effector includes a manifold and one or more vacuum suction elements in fluid communication with the manifold. The method also includes furnishing a vacuum to the manifold, and extracting the disk drive from a receptacle with the end effector.

Embodiments of the disclosed methods, systems and apparatus may include one or more of the following features.

In some embodiments, the tips are formed of silicone.

In some cases, the apparatus can also include a shelf that is disposed adjacent the vacuum suction elements and arranged to support a disk drive engaged by the vacuum suction elements. The vacuum suction elements can be movable relative to the shelf.

In some cases the apparatus can also include a shelf that is positioned adjacent the vacuum suction elements at a distance less than the distance at which deflection of a disk drive engaged by the one or more tips results in disconnection of the one or more tips from the disk drive.

The apparatus can also include a sensor (e.g., a flowrate sensor or a pressure sensor) in fluid communication with the manifold, and one or more valves in fluid communication with the one or more vacuum suction elements. Each one of the valves can be associated with a corresponding one of the vacuum suction elements. Each valve is operable to inhibit the flow of air through the associated one of the vacuum suction elements.

In some embodiments, the compliant pad includes a plurality of segments, each segment attached to one or more other ones of the segments. Each segment is in fluid communication with at least one of the one or more vacuum suction elements.

In some implementations, the segments are movable relative to each other.

The system can also include automated machinery operable to control movements of the vacuum suction elements. The automated machinery can include a robot having a moveable arm that is connected to the manifold.

The system can also include a sensor in fluid communication with the manifold, one or more valves in fluid communication with the one or more vacuum suction elements, and a controller in electrical communication with the sensor and the one or more valves.

The controller can be configured to control operation of at least one of the one or more valves based, at least in part, on signals received from the sensor.

The sensor can be a pressure sensor or a flowrate sensor.

The method can also include sequentially blocking fluid communication between the one or more vacuum suction elements and the manifold, monitoring pressure within the manifold; and eliminating fluid communication between the one or more vacuum suction elements and the manifold in the event that the pressure within the manifold exceeds a threshold pressure.

The method can also include sequentially blocking fluid communication between the one or more vacuum suction elements and the manifold, monitoring a flow rate within the manifold, and eliminating fluid communication between the one or more vacuum suction elements and the manifold in the event that the flow rate within the manifold falls below a threshold pressure.

Embodiments can include one or more of the following advantages.

In some embodiments, provision is made for objects, such as HDDs, to be mechanically engaged for removal or extraction from a cavity in which they are stored, thereby replacing a human extractor with a mechanical extractor.

In some embodiments, the systems, devices, and/or methods allow for the mechanical extraction of an object, such as a HDD, from a cavity in which it is stored, while simultaneously allowing for irregularities in the surface(s) of the HDD.

In some embodiments, the systems, devices, and/or methods allow for the mechanical extraction of an object, such as a HDD, from a cavity in which it is stored, irrespective of surface irregularities of the object.

In some embodiments, provision is made for the extraction of small-form objects from confined-space cavities, without damaging the object.

In some embodiments, provision is made for the insertion of delicate, small-form objects into confined-space cavities, without damaging the object.

In some embodiments, provision is made for the mechanical extraction of delicate, small-form objects, having one or more surfaces of irregular surface contour, from confined-space cavities, without damaging the object.

In some embodiments, provision is made for the mechanical insertion of delicate, small-form objects, having one or more surfaces of irregular surface contour, into confined-space cavities, without damaging the object.

In some embodiments, provision is made for the mechanical manipulation of delicate, small-form objects having one or more surfaces of irregular surface contour, without damaging the object.

Other aspects, features, and advantages are in the description, drawings, and claims.

### DESCRIPTION OF DRAWINGS

FIG. 1 is a schematic view of a disk drive handling system.

FIG. 2 is a perspective view of a tote and hard disk drive (HDD).

FIG. 3 is a perspective view of a HDD residing in a receptacle of a tote.

FIG. 4A is a perspective view of a vacuum assisted end effector with complaint tips.

FIG. 4B is another perspective view of the vacuum assisted end effector of FIG. 4A.

FIG. 5 illustrates the compliant tips of the end effector of FIG. 4A engaging a surface of a HDD.

FIG. 6 is a perspective view of a vacuum assisted end effector with a support shelf.

FIG. 7 is a perspective view of a vacuum assisted end effector with side grippers.

FIG. 8 is a schematic view of a vacuum assisted end effector with electronically controlled pressure and/or air flow monitoring and valving.

FIG. 9 is a perspective view of a vacuum assisted end effector with a compliant pad.

FIGS. 10A and 10B are perspective views of a vacuum assisted end effector with a compliant pad having multiple pad sections.

### DETAILED DESCRIPTION

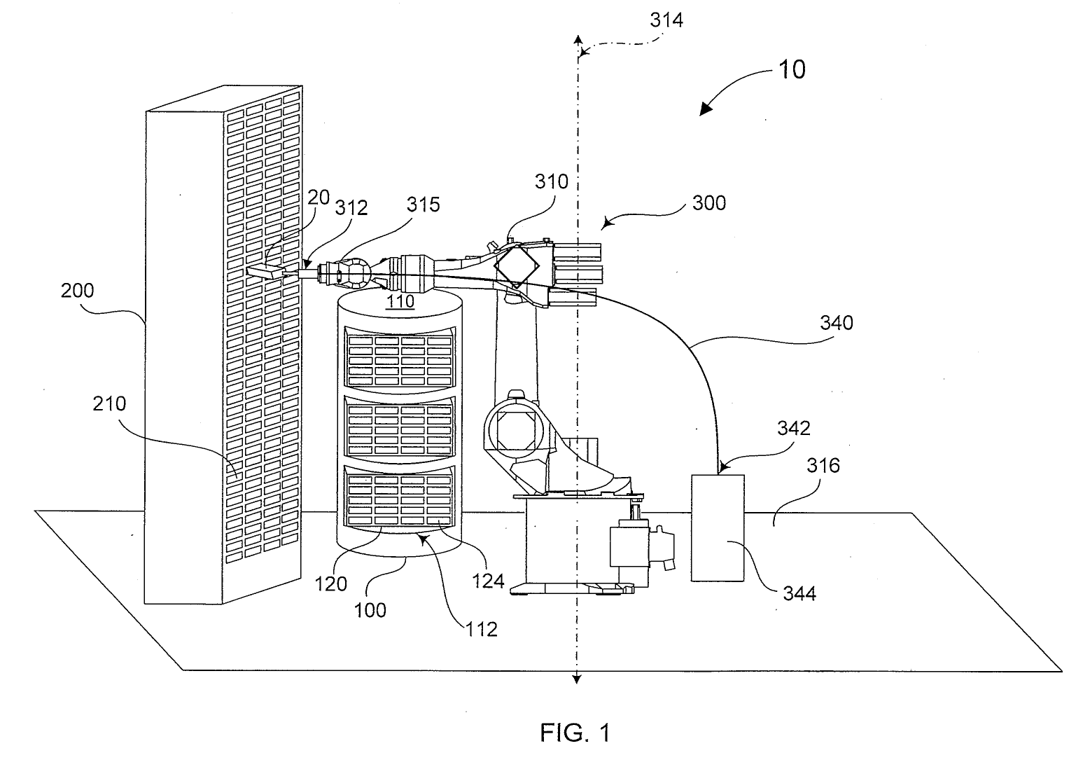

As shown in FIG. 1, a disk drive handling system 10 includes a loading station 100, a post-assembly processing station (e.g., a test station 200), and a robot 300 for moving HDDs 20 between the loading station 100 and the test station 200. The test station 200 includes a plurality of slots (e.g., test slots 210) each being configured to received an individual HDD 20, e.g., for testing. In this regard, HDDs 20 for testing are presented at the load station 100. The robot 300 is operable to move the HDDs from the load station 100 to one of the test slots 210 for testing and then remove the HDDs 20 from the respective test slot 210 and return it to the load station 100 after testing, or other post-assembly processing, is completed.

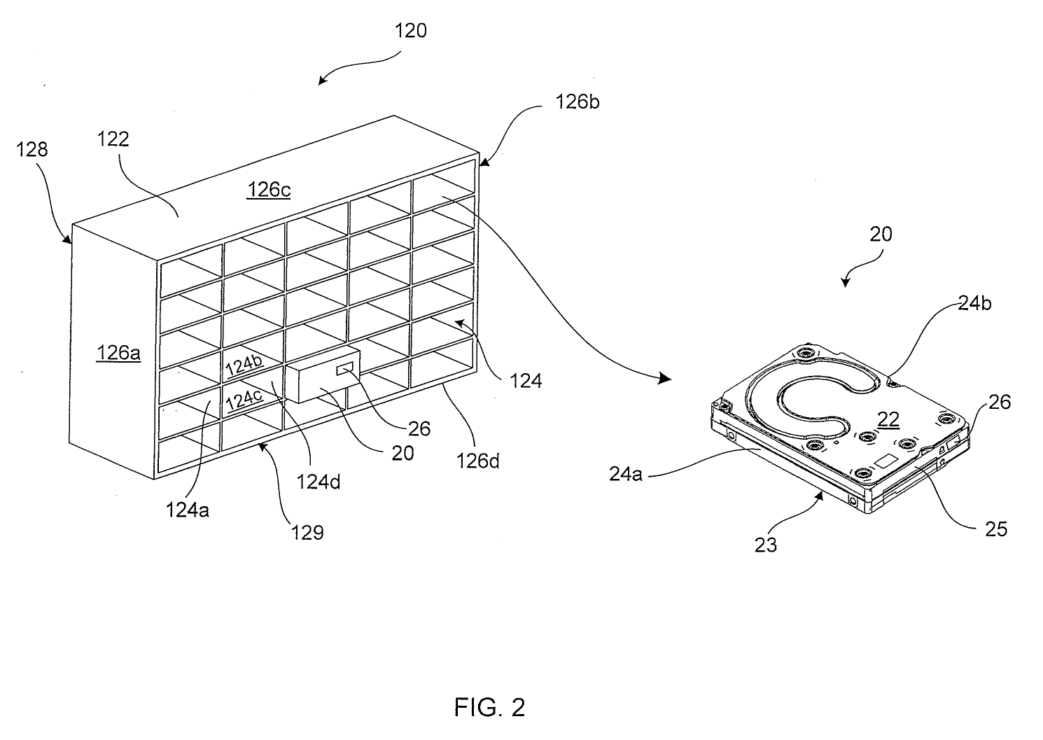

The load station 100 includes a load station body 110 that defines a set of receptacles (e.g., tote receptacles 112) for receiving carriers with HDDs. The load station 100 also includes carriers (e.g., totes 120) that are removably mounted within the tote receptacles 112. As shown in FIG. 2, the totes 120 include a tote body 122 which defines a plurality of disk drive receptacles 124 (e.g., 30 shown) configured to each house a HDD 20. The overall volume of the tote 120 is defined by side surfaces 126a, 126b, 126c, and 126d, as well as the back wall 128 and the front opening 129. Within the volume of the tote exist the disk drive receptacles 124, each disk drive receptacle 124 is defined by sidewalls 124a, 124b, 124c, and 124d. In some cases, the sidewalls defining the disk drive receptacles 124 do not extend to the plane of the front opening 129, except for those disk drive receptacles 124 which have one or more sidewalls also corresponding to the side surfaces of the tote 126a-126d. The tote 120 may also be mounted on a wheeled vehicle such as a cart, or may be incorporated into such a vehicle, thereby permitting easier transportation of the HDDs 20.

A typical HDD 20 is shown in FIG. 2. The HDD 20 includes a major top surface 22, a major bottom surface 23, side surfaces 24a and 24b, and a front surface 25. Objects such as sticker 26 may exist on the front surface 25, presenting a surface of irregular contour. A circuit board frequently exists on one or more of the major surfaces 22 or 23, covering, and thus comprising, the entire surface.

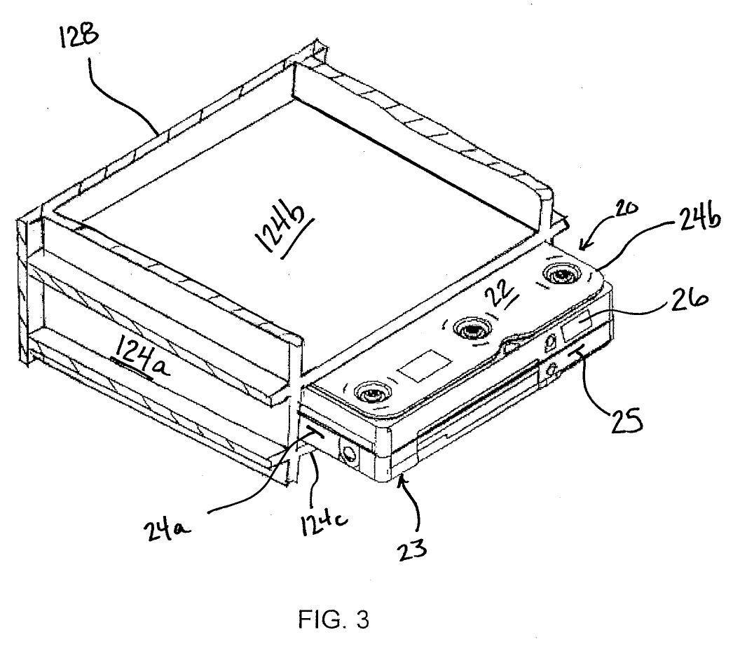

As illustrated in FIG. 3, when a HDD 20 is inserted into one of the receptacles 124, only a small portion of the surface area of HDD surfaces 22, 23, 24a ,24b, and 25 extend beyond the front edges of receptacle sidewalls 124a, 124b, 124c, and 124d. Thus, only a relatively small area is presented, at least initially, for manipulation by the robot 300.

Referring again to FIG. 1, the robot 300 includes a robotic arm 310 and an end effector (or manipulator) 312 disposed at a distal end 315 of the robotic arm 310. The robotic arm 310 defines a first axis 314 substantially normal to a floor surface 316 and is operable to rotate through a predetermined arc about and extends substantially radially from the first axis 314. The robotic arm 310 is configured to independently service each test slot 210 by transferring HDDs 20 between the load station 100 and the test station 200. In particular, the robotic arm 310 is configured to remove a HDD 20 from one the disk drive receptacles 124 at the load station 200 with the end effector 312, and then move the HDD 20 to the test slot 210, e.g., for testing of the HDD 20. After testing, the robotic arm 310 retrieves the HDD 20 from the test slot 210 and returns it to one of the disk drive receptacles 124 at the load station 200.

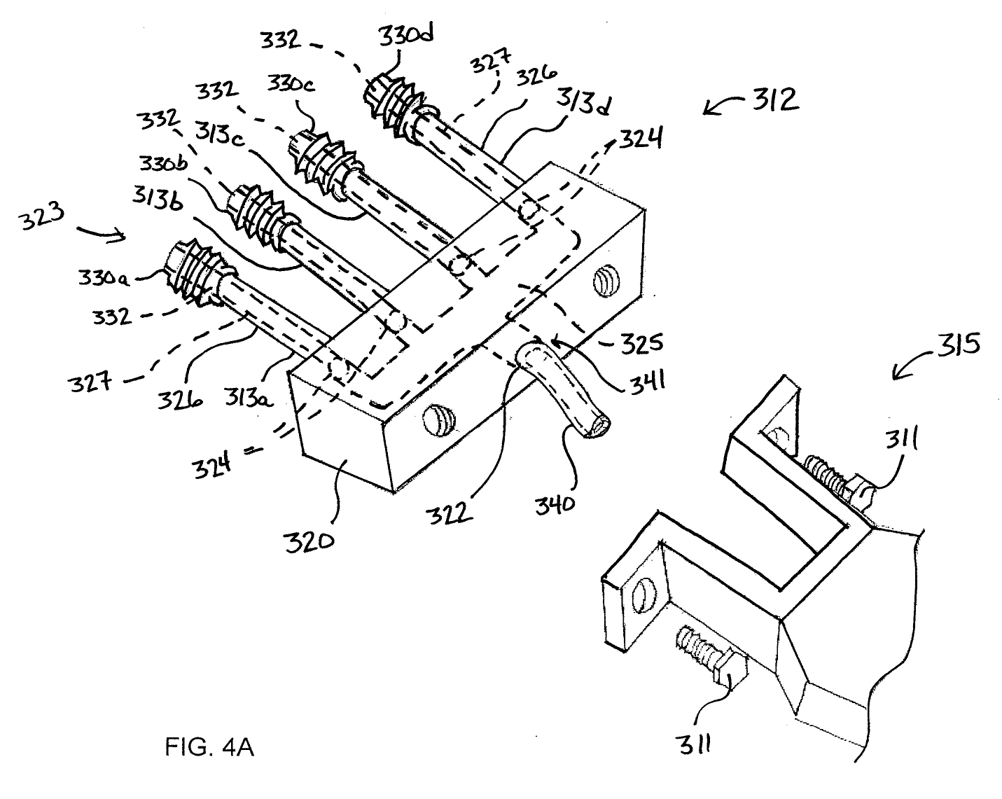

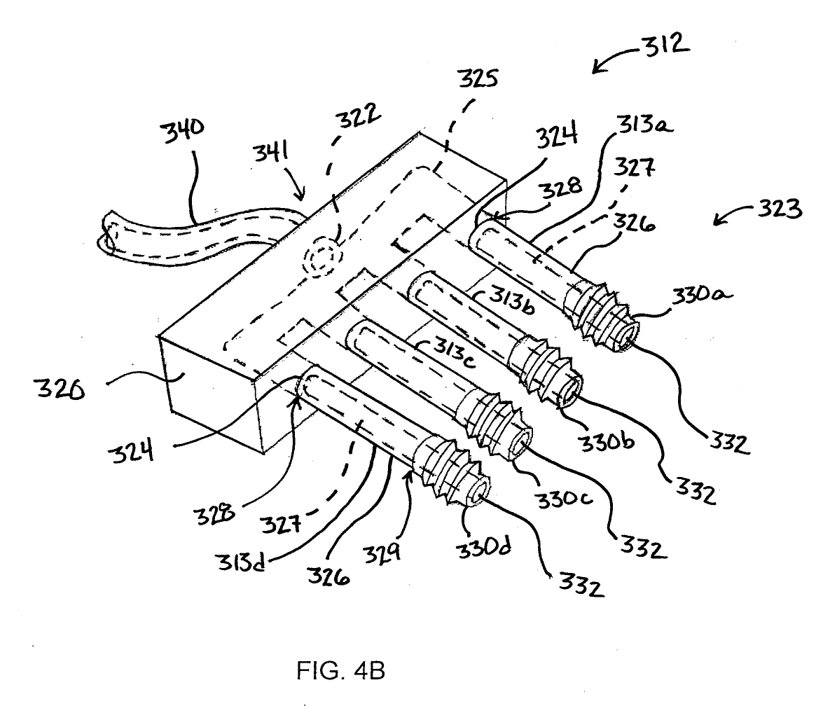

As shown in FIGS. 4A and 4B, in one embodiment, the end effector 312 includes a manifold 320 and a plurality of grippers (or vacuum suction elements 313a-313d). The vacuum suction elements 313a-313d are arranged in a substantially linear array (i.e., a vacuum effector array or a gripper array 323) along a front face of the manifold 320. The manifold 320 includes an outlet port 322 and a plurality of inlet ports 324 that are in fluid communication with the outlet port 322 via a vacuum conduit 325 that is defined by the manifold 320. The manifold 320 is rigidly mounted to the distal end 315 of the robotic arm 310 (FIG. 1) e.g., via mounting hardware 311.

Each of the vacuum suction elements 313a-313d includes a substantially hollow tube 326 with a vacuum lumen 327 that extends from a proximal end 328 (FIG. 4B) of the tube 326 to a distal end 329 of the tube 326. An associated tip 330a-330d is mounted at or near the distal end 329 of each of the tubes 326. The tips 330a-330d are compliant in one or more axes of motion, and may be formed, e.g., of silicone rubber. The tips 330a-330d are generally hollow, tubular shaped elements which define fluid passageways 332 that are sized to be less than (e.g., smaller in diameter) the thickness of the HDD 20 which the vacuum suction elements 313a-313d are intended to engage.

At their respective proximal ends 328, the vacuum suction elements 313a-313d are each connected with a corresponding one of the inlet ports 324 such that their respective vacuum lumen 327 are in fluid communication with the vacuum conduit 325 of the manifold 320. An inlet tube 340 is connected, at a first end 341, to the outlet port 322 of the manifold 320. The inlet tube 340 is connected, at a second end 342 (FIG. 1), to a vacuum source 344 (FIG. 1),e.g., a vacuum pump. The vacuum source 344 creates a vacuum which ultimately draws the surrounding atmosphere through the fluid passageways 332 of the tips 330, which may then be used to engage a surface, such as a surface 25 of a HDD 20.

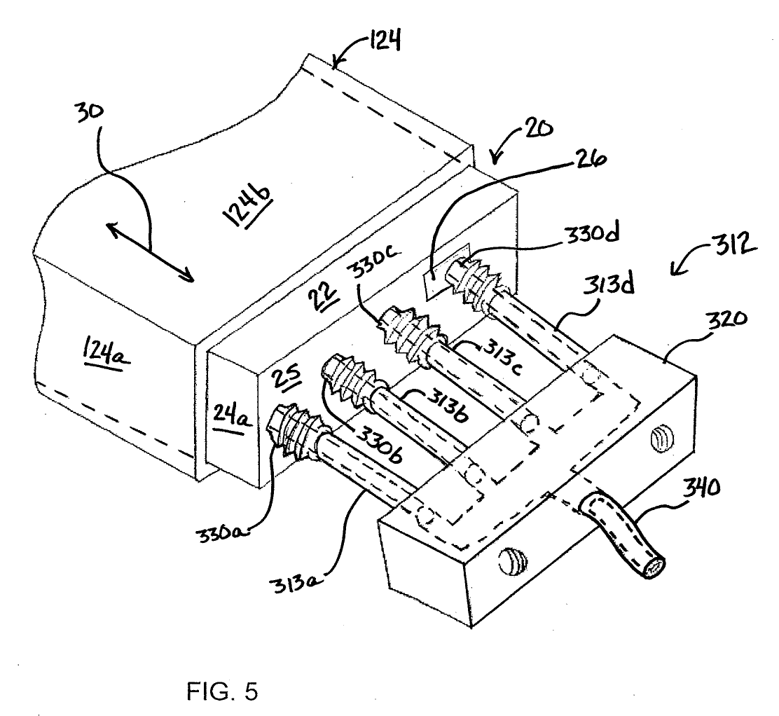

FIG. 5 illustrates the vacuum suction elements 313a-313d engaging the front surface 25 of a HDD 20. The compliance of the tips 330a-330d allows the tips 330a-330d engaging a surface irregularity or surface feature, such as a sticker 26, to substantially conform to the irregular surface contour formed by sticker 26 and front surface 25, thus providing a seal and enabling the robot 300 (FIG. 1) and the end effector 312 to, as they move in a direction substantially parallel to an axis 30 of the HDD 20 which is constrained by the receptacle 124, remove the HDD 20 from its receptacle 124 within the tote 120 (FIG. 2).

### Other Embodiments

While certain embodiments have been described above other embodiments are possible.

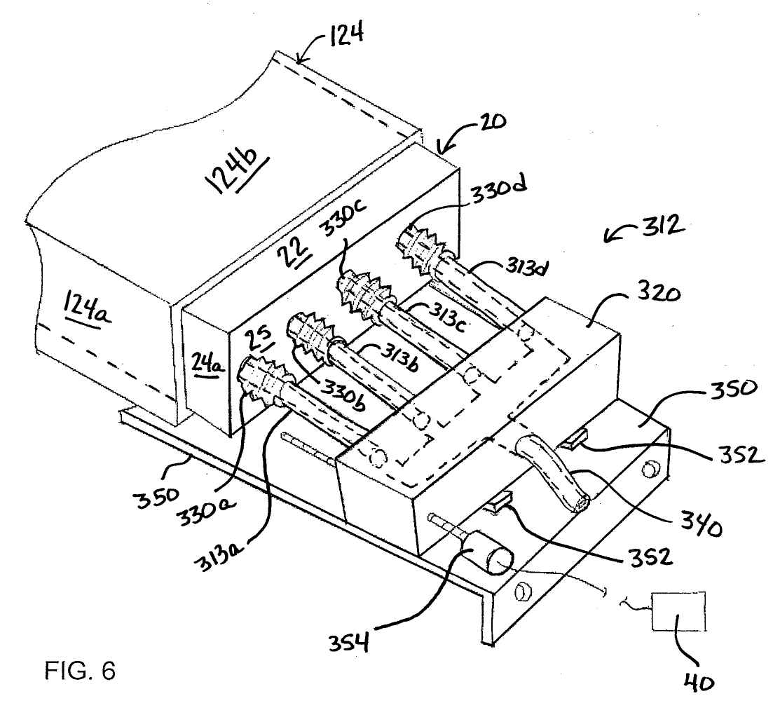

For example, referring to FIG. 6, in some embodiments, a support (e.g., a shelf 350) can be added to further support the removed HDD 20 such that all the mass of the HDD 20 need not be supported by the vacuum suction elements 313a-313d.

During extraction of HDD 20 from the receptacle 124 or insertion of HDD 20 into receptacle 124, vacuum suction elements 313a-313d may move substantially horizontally, independent of the shelf 350, to facilitate removal or insertion of HDD 20. For example, the shelf 350 may be rigidly connected to the distal end 315 (FIG. 1) of the robotic arm 310 (FIG. 1), and the manifold 320 may be connected to the distal end 315 (FIG. 1) of the robotic arm 310 (FIG. 1) via the shelf 350. Specifically, the manifold 320 may be connected to the shelf 350 by linear bearings 352, and/or a linear motion slide, which allows the manifold 320 to move relative to the shelf 350. Movement of the manifold 320, relative to the shelf 350, may be controlled by a linear actuator 354, or, alternatively, a solenoid, under the control of a process controller 40.

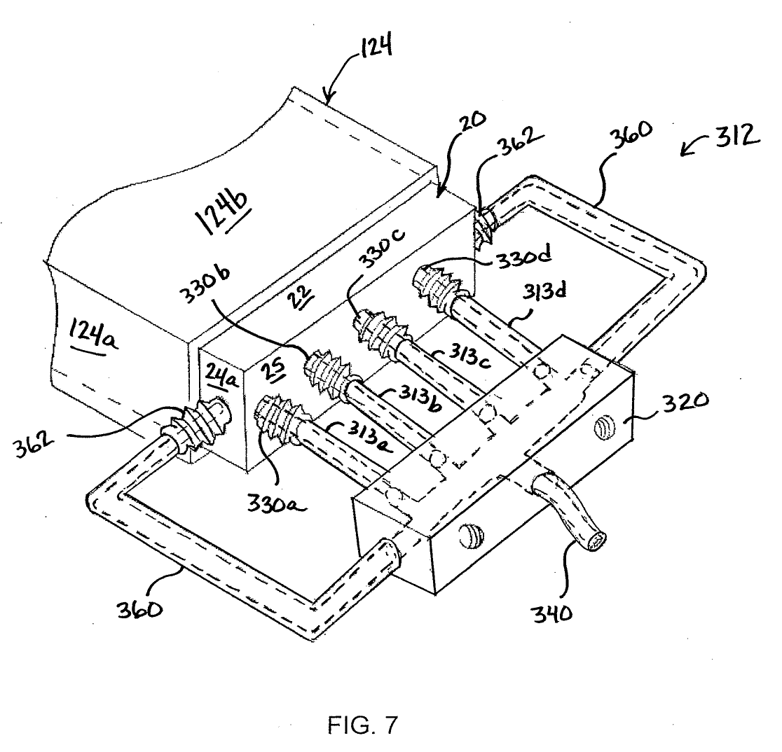

Referring to FIG. 7, in some embodiments, further vacuum suction elements or side grippers 360 and tips 362 can be used to grasp the sides 24a and 24b of the HDD 20 to facilitate its complete removal from the tote 120 (FIG. 2), allowing the HDD 20 to be transported to another area (e.g., test station 200 (FIG. 1)) for use or post-assembly processing.

In some cases, there may exist sufficient surface irregularities to prevent the vacuum suction elements or grippers 313a-313d from affixing themselves to the HDD front surface 25 with sufficient holding force, given the limits of suction available on the end effector 312, to overcome the retention forces retaining the HDD 20 within disk drive receptacle 124.

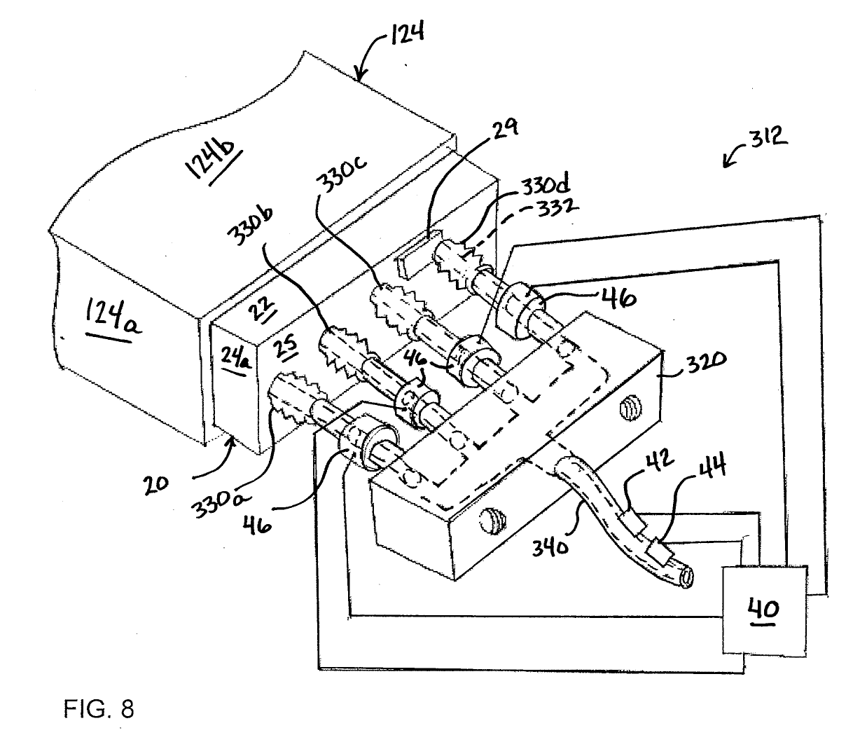

Thus, the end effector 312 may include manifold sensors and valving. For example, as shown in FIG. 8, the tips 330a-330d have engaged the HDD front surface 25, but the tip 330d has encountered a surface irregularity 29. As a result, there is no seal between the fluid passageway 332 of the tip 330d and surface 25, with a leak preventing the manifold 320 from attaining its intended vacuum level, and there is a possibility that the force exerted on surface 25 to extract the HDD 20 from the disk drive receptacle 124 is insufficient.

However, a pressure sensor 42 may report to a process controller 40 that the manifold pressure is lower than a minimum or threshold pressure. Alternatively or additionally, an airflow rate sensor 44 may report to the process controller 40 that the airflow rate to the manifold 320 exceeds a maximum or threshold value. The process controller 40 may then actuate a valve 46, blocking the tip 330d from the suction source manifold 320. The result is that retention force which the array 323 exerts upon HDD front surface 25 is not as significantly compromised as would be the case without blockage of the tip 330d, and the HDD 20 may be removed from its disk drive receptacle 124.

To determine which of the tips 330a-330d to block, the controller 40 might block flow to each of the tips 330a-330d in turn by sequentially closing each of the respective valves 46 and monitor the resulting manifold pressure or the flowrate from the manifold 320. When closure of a valve 46 results in an increase in manifold pressure above the threshold pressure or a decrease in manifold flowrate below the threshold flowrate, a defective tip seal has been identified. If no valve closure has an effect on the manifold pressure or manifold flowrate, all manifold tips 330a-330d are subject to effective seals with the HDD front surface 25.

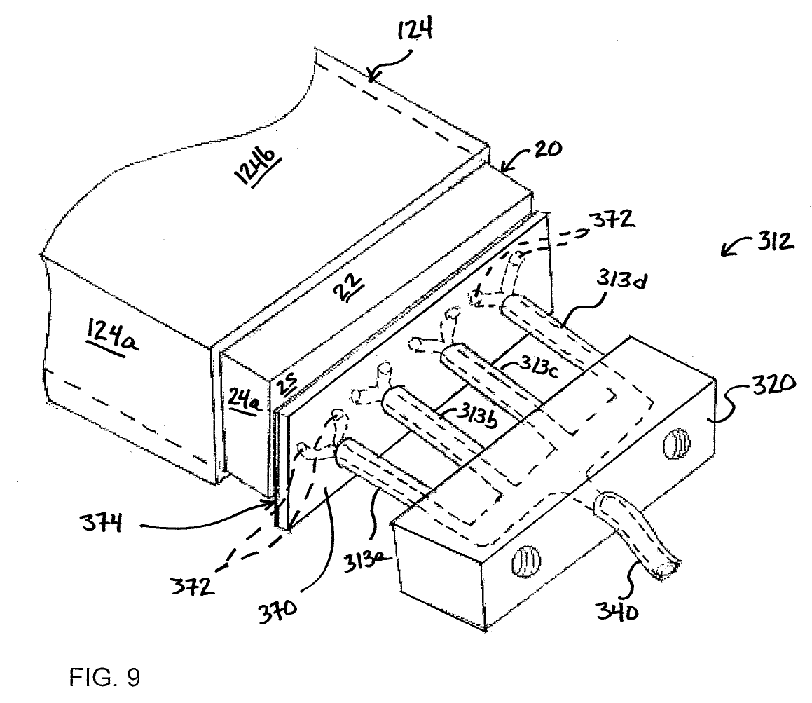

In another embodiment, referring to FIG. 9, the end effector 312 includes a compliant pad 370 containing a network of many small holes or passages 372 permitting fluid communication between the manifold 320 and a front, semi-rigid, surface 374 of the end effector 312. Surfaces of the compliant pad 370 other than front surface 374 are substantially sealed, thereby preventing entry of air at these locations upon application of suction to the vacuum suction elements 313a-313d. The vacuum furnished to the manifold 320 is distributed over the HDD's front surface 25, and the compliant nature of the pad 370 conforms to surface irregularities.

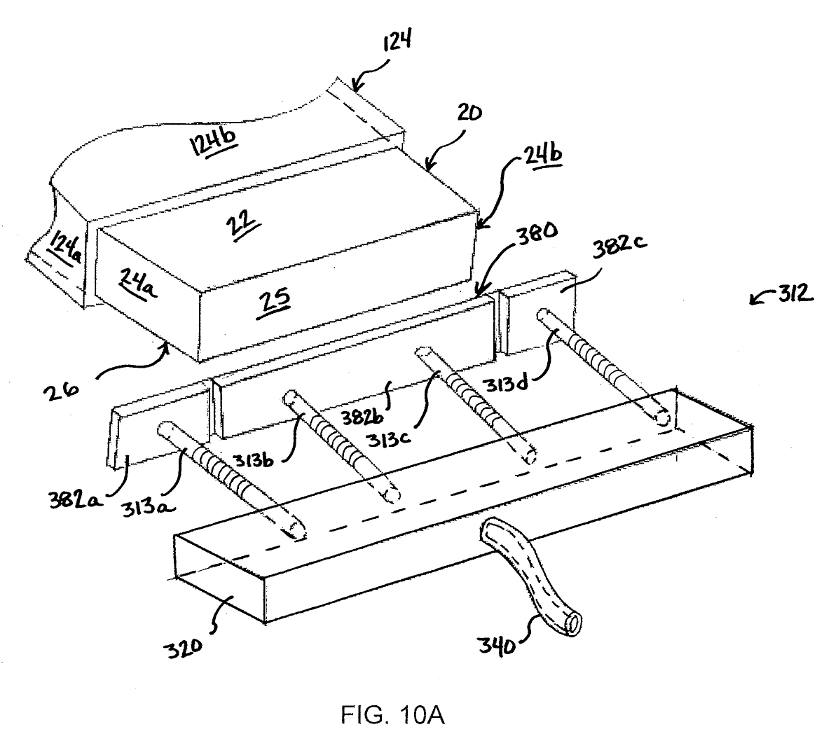

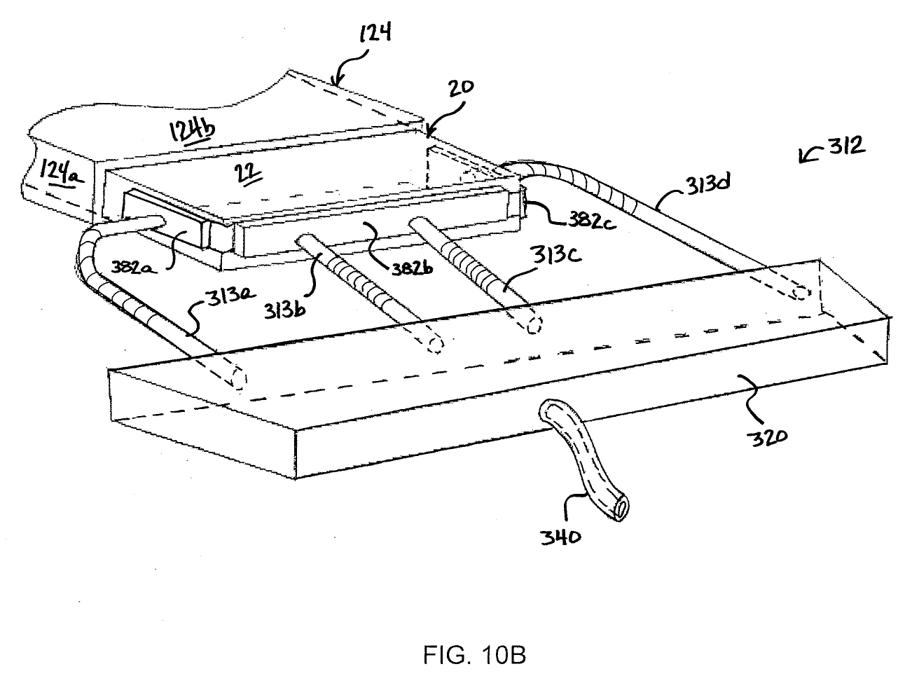

In a further embodiment shown in FIG. 10A, the end effector 312 is configured with a compliant pad 380 having one or more compliant pad segments, in this case, compliant pad segments 382a, 382b, and 382c, so that the compliant pad segments engage one or more surfaces of the HDD 20 (top 22, bottom 23, left side 24a, and right side 24b). The compliant pad segments 382a, 382b, and 382c may or may not be coupled to one another. As vacuum is applied to the manifold 320, the HDD 20 is held securely against the end effector 312. The vacuum suction elements 313a-313d may be telescoping or extendable and, in some cases, pliable, to permit the compliant pads 382a, 382b, and 382c to conform, for example, with the top 22, front 25, and bottom 23 or with the left 24a, front 25, and right 24b surfaces (see, e.g., FIG. 10A) of the HDD 20, as shown in FIG. 10B.

In view of the increased surface area of the HDD 20 subjected to a given vacuum or less than ambient pressure by the compliant pads 382a, 382b, and 382c, the limiting force that the gripper array 323 can exert on the HDD 20 may be increased from the limiting force in the embodiment including the tips 330. From another perspective, the force necessary for extraction of the HDD 20 may be produced with a lesser vacuum. As a result, there is less stress on the front 25, top 22, bottom 23, left 24a, and right 24b surfaces of the HDD 20 using compliant pads 370 or 380 as compared to using the tips 330 and, consequently, less risk of damage to the HDD 20.

Other embodiments are within the scope of the following claims.

What is claimed is:

1. A disk drive handling apparatus comprising:
a manifold;
one or more vacuum suction elements in fluid communication with the manifold; and
one or more tips, each tip coupled to an end of a corresponding one of the vacuum suction elements,
wherein each tip is compliant in one or more axes of motion.

2. The apparatus of claim 1, wherein the tips are formed of silicone.

3. The apparatus of claim 1, further comprising:
a shelf disposed adjacent the vacuum suction elements and arranged to support a disk drive engaged by the vacuum suction elements.

4. The apparatus of claim 3, wherein the vacuum suction elements are movable relative to the shelf.

5. The apparatus of claim 1, further comprising:
a shelf,
wherein the shelf is positioned adjacent the vacuum suction elements at a distance less than the distance at which deflection of a disk drive engaged by the one or more tips results in disconnection of the one or more tips from the disk drive.

6. The apparatus of claim 1, further comprising:
a sensor in fluid communication with the manifold; and
one or more valves in fluid communication with the one or more vacuum suction elements.

7. The apparatus of claim 6, wherein each one of the valves is associated with a corresponding one of the vacuum suction elements, and wherein each valve is operable to inhibit the flow of air through the associated one of the vacuum suction elements.

8. The apparatus of claim 6, wherein the sensor is a flowrate sensor or a pressure sensor.

9. A disk drive handling apparatus comprising:
a manifold;
one or more vacuum suction elements in fluid communication with the manifold; and
a compliant pad comprising a plurality of passages in fluid communication with the one or more vacuum suction elements.

10. The apparatus of claim 9, wherein the compliant pad further comprises a plurality of segments, each segment attached to one or more other ones of the segments, and wherein each segment is in fluid communication with at least one of the one or more vacuum suction elements.

11. The apparatus of claim 10, wherein the segments are movable relative to each other.

12. A disk drive handling system comprising:
a vacuum source;
a manifold in fluid communication with the vacuum source;
one or more vacuum suction elements in fluid communication with the manifold;
one or more tips, each tip coupled to an end of a corresponding one of the vacuum suction elements;
wherein each tip is compliant in one or more axes of motion.

13. The disk drive handling system of claim 12, further comprising:
automated machinery operable to control movements of the vacuum suction elements.

14. The disk drive handling system of claim 13, wherein the automated machinery comprises a robot including a moveable arm connected to the manifold.

15. The disk drive handling system of claim 12, wherein the system further comprises:
a sensor in fluid communication with the manifold;
one or more valves in fluid communication with the one or more vacuum suction elements, and
a controller in electrical communication with the sensor and the one or more valves.

16. The disk drive handling system of claim 15, wherein the controller is configured to control operation of at least one of the one or more valves based, at least in part, on signals received from the sensor.

17. The disk drive handling system of claim 15, wherein the sensor is a pressure sensor.

18. The disk drive handling system of claim 15, wherein the sensor is a flowrate sensor.

19. A disk drive handling system comprising:
a vacuum source;
a manifold in fluid communication with the vacuum source;
one or more vacuum suction elements in fluid communication with the manifold; and
one or more compliant pads, the one or more compliant pads comprising a plurality of passages in fluid communication with the one or more vacuum suction elements.

20. The disk drive handling system of claim 19, further comprising:
automated machinery operable to control movements of the vacuum suction elements.

21. The disk drive handling system of claim 20, wherein the automated machinery comprises a robot including a moveable arm connected to the manifold.

22. The disk drive handling system of claim 19, wherein the system further comprises:
a sensor in fluid communication with the manifold;
one or more valves in fluid communication with the one or more vacuum suction elements, and
a controller in electrical communication with the sensor and the one or more valves.

23. The disk drive handling system of claim 22, wherein the controller is configured to control operation of at least one of the one or more valves based, at least in part, on signals received from the sensor.

24. The disk drive handling system of claim 22, wherein the sensor is a pressure sensor.

25. The disk drive handling system of claim 22, wherein the sensor is a flowrate sensor.

26. A method of handling a disk drive, the method comprising:
engaging one or more surfaces of a disk drive with an end effector, the end effector comprising a manifold and one or more vacuum suction elements in fluid communication with the manifold;
furnishing a vacuum to the manifold; and
extracting the disk drive from a receptacle with the end effector.

27. The method of claim 26, further comprising:
sequentially blocking fluid communication between the one or more vacuum suction elements and the manifold;
monitoring pressure within the manifold; and
eliminating fluid communication between the one or more vacuum suction elements and the manifold in the event that the pressure within the manifold exceeds a threshold pressure.

28. The method of claim 25, further comprising:
sequentially blocking fluid communication between the one or more vacuum suction elements and the manifold;
monitoring a flow rate within the manifold; and
eliminating fluid communication between the one or more vacuum suction elements and the manifold in the event that the flow rate within the manifold falls below a threshold pressure.
